(19) United States
(12) Patent Application Publication
(10) Pub. No.: US 2015/0261709 A1
(43) Pub. Date: Sep. 17, 2015

(54) PERIPHERAL COMPONENT INTERCONNECT EXPRESS (PCIE) DISTRIBUTED NON- TRANSPARENT BRIDGING DESIGNED FOR SCALABILITY,NETWORKING AND IO SHARING ENABLING THE CREATION OF COMPLEX ARCHITECTURES.

(71) Applicant: Emilio Billi, San Jose, CA (US)

(72) Inventor: Emilio Billi, San Jose, CA (US)

(21) Appl. No.: 14/214,573

(22) Filed: Mar. 14, 2014

(51) Int. Cl. G06F 13/40

(52) U.S. Cl. CPC G06F 13/4022

(57) ABSTRACT

A highly scalable distributed non-transparent memory bridging for Peripheral Component Interconnect (PCI) express (PCIe) switches based on a globally shared memory architecture with ID based routing that overcomes the limitations of traditional PCIe non-transparent bridging and more particularly is related to a PCI Express multiport switch architecture based on an implementation of the distributed non-transparent memory bridging that enables the creation of multi root PCIe architectures with scalability on the order of tens of thousands of nodes with networking capabilities, advanced flow controls, and Input/Output (IO) virtualization.

### CROSS REFERENCE TO RELATED APPLICATIONS

The present application is a continuation-in-part of co-pending U.S. Patent Provisional Application Ser. No. 61/786,537, entitled “PCIe Non-Transparent Bridge Designed for Scalability and Networking Enabling the Creation of Complex Architecture with ID Based Routing”, filed Mar. 15, 2013.

### BACKGROUND OF THE INVENTION

1. Field of Invention

This invention is related to a highly scalable distributed non-transparent memory bridging for Peripheral Component Interconnect (PCI) express (PCIe) switches based on a globally shared memory architecture with ID based routing that overcomes the limitations of traditional PCIe non-transparent bridging and more particularly is related to a PCI Express multiport switch architecture based on an implementation of the distributed non-transparent memory bridging that enables the creation of multi root PCIe architectures with scalability on the order of tens of thousands of nodes with networking capabilities, advanced flow controls, and Input/Output (IO) virtualization.

2. Description of Related Art

Distributed systems are the current standard for data center and cloud computing. Multi-host systems provide not only the ability to increase processing bandwidth, but also allow for greater system reliability through host failover. These features are important, especially in the storage and communication devices and systems. The PCI Express specification does not standardize the implementation of multi-processor systems. Because of this, distributed processing implementations using PCI Express have been limited and with no standardized approach. PCI and PCIe did not anticipate multi-root architectures. The design of the PCIe architecture was with the assumption that the host processor would enumerate the entire memory space. Obviously, if another processor is added, the system operation would fail as both processors would attempt to service the system requests. To overcome this limitation, the industry introduced the concept of non-transparent bridging (NTB). The use of non-transparent bridges in PCI systems to support intelligent adapters in enterprise systems and multiple processors in embedded systems is well established. Non-transparent bridges isolate intelligent subsystems from each other by masquerading as end points to discovery software and translating the addresses of transactions that cross the bridge. A non-transparent bridge is functionally similar to a transparent bridge in that both provide a path between two independent PCI buses (or PCI or PCI Express buses). The key difference is that when a non-transparent bridge is used, devices on the downstream side (relative to the system host) of the bridge are not visible from the upstream side. A non-transparent bridge typically includes doorbell registers to send interrupts from each side of the bridge to the other and scratchpad registers accessible from both sides for inter-processor communications. The introduction of the non-transparent bridging enables the creation of an interconnection network based on PCIe with distributed IO sharing. There are many examples of PCIe-based clusters that demonstrate the potential of this technology. The big problem related with current PCIe non-transparent bridging architecture is that the non-transparent bridging is not specifically designed for networking and it does not have important features needed by a modern interconnection technology like strong flow control, congestion management, multi topology support and so on. PCIe is not designed to support efficient network topologies.

There is a need for a PCIe non-transparent bridging that is expressly designed for scalability and networking applications that can be combined with the transparent PCIe switching technology. There is the need of a non-transparent bridging architecture designed specifically for modern datacenters that is able to overcome all the limitations that today PCIe and related NTB have.

### SUMMARY

Briefly, Invention provides an efficient way to extend the functionality of the PCIe non-transparent bridging using a completely new approach based on a global shared memory architecture. The invention is based on the extension of the inter domain memory mapping used by PCIe NTB with a mapping of the PCIe memory on at least a 64 bit shared memory capable bus in order to create a large globally shared memory providing at the same time the memory domain isolation between different root complex and CPUs.

In the non-transparent bridging environment, PCI Express systems need to translate addresses that cross from one memory space to the other.

To do that PCIe base address registers (BARs) are used to define address-translating windows into the memory space and allow the transactions to be mapped to the local memory or I/Os.

Memory apertures are set up by a driver so that queues on each system can be seen and accessed between the systems.

At the NTB ports, translation tables are set up for memory addresses and transaction layer packets (TLPs), so that transactions are translated as they pass through the NTB ports.

The memory apertures in NTB design are set up using look up tables (LUTs).

The memory domains are separated opening and closing the memory transaction inside a single device. Memory operations that target a memory window defined by a non-transparent end point (EP) are routed within the domain to that endpoint. When the non-transparent bridge receives a memory operation that targets a BAR used for mapping through the bridge, it translates the address of the transaction into a new address in the second memory domain and forwards the transaction to the other domain. Completions are handled in the similar manner. All these operations are done inside a single device. A standard non-transparent bridge consists of two PCI functions defined by a Type header that are interconnected by a bridge function. The two functions are referred as Non-transparent (NT) end point. The two functions are realized always inside a single chip.

The present invention extends the same concept outside a single device using at least 64 bit memory-mapped bus that realizes a global shared memory address space among multiple devices, in that way, the two NTB functions can belong to two physically different chips. In that way the memory translation can be opened in one device and closed directly into a remote one resulting in a distributed non-transparent bridge that implements the same concept of the standard NTB and performs equivalent operations.

In general, in one aspect, the invention relates to a new way to provide the non-transparent bridging functionality using a secondary, low latency, highly efficient protocol that bridges the PCIe memory, that belong to a domain, with the memory of another domain in a highly scalable distributed environment, independently if the two domains are inside the same chip or belongs to two or more different devices. This opens the possibility to create virtually unlimited scalable PCIe switches and networks based on a globally shared memory address space. The bus used for the non-transparent bridging and the hardware core that implements it will provide also all the capabilities needed for a robust inter-processor network fabric, including link to link flow control, end to end flow control, traffic congestion management, complex routing capabilities, support for any topology like, but not limited at, 1D, 2D, 3D, xD Torus and derived topologies, 1D, 2D, 3D, nD Hypercube topologies, tree topologies, star topologies, with built in fault tolerant architectures.

In some embodiments, the invention can be realized in PCIe Upstream-NTB simple building block that represents the minimal working configuration, providing an efficient way to create distribute PCIe NTB fabric with large scalability and very efficient internetworking capabilities with no PCIe downstream transparent ports for I/O connectivity.

In some embodiments, the invention can be realized in PCIe Upstream-NTB fabric configuration with many PCIe transparent bridging ports, downstream ports, connected to the root complex providing an efficient way to connect multiple root complex and different PCIe end points in the same fabric enabling the creation of hybrid multi root PCIe fabric with PCIe end point virtual sharing capabilities and node to node internetworking capability with high scalability in a single fabric.

In some embodiments, the invention can be realized to create a large single chip multi NTB port combined with transparent bridging capabilities and PCIe transparent ports connected in a way that each root complex can have one or more transparent ports (downstream ports in the PCIe switch convention) connected directly to it using the standard PCIe transparent bridging and switching architecture. Each of this group of ports is composed exclusively of one single root complex port (upstream port in the PCIe switch convention) and some (at least one) transparent (downstream) ports. Each group defines a single standalone memory domain thanks to the memory isolation provided by the distributed non-transparent bridging (dNTB). Each of these downstream ports is directly accessible by the root complex that belongs to the same memory domain of the downstream ports and it is accessible by all other root complex using the memory mapping provided by the distributed NTB interconnection bus. This architecture permits the creation of an efficient memory based I/O virtualization.

In some embodiments the invention, can be equipped with an embedded microprocessor that performs the enumeration of the end points connected to the transparent downstream ports eliminating the needing to have a root complex CPU connected to the switch. This represents a special application of the invention that can be used to connect a standalone PCIe end point to a distributed non-transparent network fabric or many standalone PCIe end points to a distributed non-transparent network fabric. This special configuration permits the creation of clustered shared I/Os.

In some embodiments of the invention, single switches can be connected together using the distributed NTB fabric in order to create a single system like a large single switch with both NTB ports and downstream transparent ports in any combination.

In general, embodiments of the invention relate to a PCIe switch assembly based on a scalable distributed non transparent bridging realized using a secondary bus with global shared memory address space capability that overcomes the limitations of today's PCIe non-transparent bridging architecture and permits the realization of a robust, highly scalable, low latency PCIe based multi-root fabric with the capability to support direct memory based I/O virtualization. The switch assembly comprises, among other things, at least one upstream port for root complex connection, a non-transparent bridge core based on a globally shared memory bus with all the features needed by a multi-CPU distributed network fabric like flow control, congestion management, support for any network topologies, at least one port for non-transparent bridging interconnection used to connect different upstream local or remote ports using any kind of network topologies.

Additional and/or alternative aspects of the invention will become apparent to those having ordinary skill in the art from the accompanying drawings and following detailed description of the disclosed embodiments.

### BRIEF DESCRIPTION OF THE DRAWINGS

FIG. 1 represents the organization and the communication using the distributed NTB approach.

FIG. 2 shows a possible simplified implementation of the translation mechanism used in the distributed NTB.

FIG. 3 shows a possible configuration where the root complex upstream port (1) is connected to a PCIe switch.

FIG. 3a shows in one preferred embodiment the switch core configuration where an embedded CPU (1) is used for the PCIe enumeration of the local EPs.

FIG. 3b shows in one preferred embodiment the switch core with the dNTB functionality.

FIG. 3c shows how the dNTB core is organized.

FIG. 4 shows in one preferred embodiment how the communication is performed between two different distributed NTB ports or fabric.

FIG. 4b shows the differences between the PCIe NTB as today implemented and the dNTB demonstrating the major efficiency of the dNTB compared with the standard NTB.

FIG. 5 shows, in some embodiments, how multiple switches can be connected together using dNTB fabric in order to create a large scalable unified PCIe switch combining the entire feature described.

FIG. 6 shows some possible topologies supported by the dNTB fabric.

FIG. 7 shows a possible single chip embodiment of the dNTB cores and related switches.

### DETAILED DESCRIPTION OF THE PREFERRED EMBODIMENTS

The figures described above and the written description of specific structures and functions below are not presented to limit the scope of what Applicants have invented or the scope of the appended claims. Rather, the figures and written description are provided to teach any person skilled in the art to make and use the inventions for which patent protection is sought. Those skilled in the art will appreciate that not all features of a commercial embodiment of the inventions are described or shown for the sake of clarity and understanding. Persons of skill in this art will also appreciate that the development of an actual commercial embodiment incorporating aspects of the present inventions will require numerous implementation-specific decisions to achieve the developer's ultimate goal for the commercial embodiment. Such implementation-specific decisions may include, and likely are not limited to, compliance with system-related, business-related, government-related and other constraints, which may vary by specific implementation, location, and from time to time. While a developer's efforts might be complex and time-consuming in an absolute sense, such efforts would be, nevertheless, a routine undertaking for those of skill in this art having benefit of this disclosure. It must be understood that the inventions disclosed and taught herein are susceptible to numerous and various modifications and alternative forms. Lastly, the use of a singular term, such as, but not limited to, “a,” is not intended as limiting of the number of items. Also, the use of relational terms, such as, but not limited to, “top,” “bottom,” “left,” “right,” “upper,” “lower,” “down,” “up,” “side,” and the like are used in the written description for clarity in specific reference to the figures and are not intended to limit the scope of the invention or the appended claims.

As will be further described below, in an embodiment of the invention, a PCIe non-transparent bridging (NTB) is disclosed that is expressly designed for scalability and networking application that can be combined with the transparent PCIe switching technology enabling the creation of complex architectures with many interesting features like high availability among multiple servers, sharing of remote I/Os, and message passing applications. An NTB architecture is presented that has built-in interconnection network capabilities with high level of scalability, advanced flow control, quality of services, support for high availability and support for multiple network topologies. The non-transparent bridging architecture of the various embodiments and methods of the invention are designed specifically for modern datacenters and overcome all limitations that today's PCIe and related NTB have.

The use of non-transparent bridges (NTB) in PCI systems to support intelligent adapters in enterprise systems and multiple processors in embedded systems is well established. The scope of NTB is to isolate intelligent subsystems from each other by masquerading as endpoints to PCIe discovery mechanism and software, and translating the addresses of transactions that cross the bridge.

Non-transparent bridging (NTB) is not governed by the PCI-SIG PCI Express® industry standards, for that reason NTB can be implemented in many different and property way by different PCIe switch vendors.

All these implementations are based on the concept of address translation between different memory domains. Different root complex ports must belong to different memory domains. The translations are performed using the PCIe base address register.

A typical existing NTB working mechanism has two NTB end point ports (EP), with the 1^{st} one being an internal NTB EP port and the second one being an external NTB EP port for the sake of presenting an example. A memory translation is performed between the two NTB end points. The internal and external endpoints may each be configured to support 32-bit address window or 64-bit address windows. Each base address register (BAR) has a corresponding setup register and translated base register in the internal and external end point configuration structure. The setup register contains fields that configure the corresponding BAR, such as the type of BAR (Memory or I/O) and the address window. The translated base register contains the base address of the transactions forwarded through the existing non-transparent bridge using the corresponding BAR. The base address of a BAR corresponds to those address bits which are examined to determine if an address falls into a region mapped to a BAR. This mechanism explains how the address is translated when a packet is forwarded from the internal end point to the external end point. The address translation works exactly the same when a packet is forwarded from the external endpoint to the internal end point. When a packet is received by the internal end point, the address field is extracted from the PCIe transaction layer packet. The address and type are compared against BAR0 through BAR3. If the address falls within the window size of one of the BARs, the base address of the original address is replaced with the content of the corresponding Translated Base Address Register before the packet is forwarded. If the address does not find a match in BAR0 to BAR3, the packet is dropped. Many algorithms are contemplated that can be implemented to perform complex routing function between multiple ports and end points. Using these mechanisms, the non-transparent bridge also allows hosts on each side of the bridge to exchange information about the status through scratchpad registers, doorbell registers, and heartbeat messages. The two NTB ports belong to the same PCIe switch chip.

Using existing PCIe NTB it is possible to connect few different systems or switches and it is possible to communicate between multiple CPUs or between a CPU and multiple PCIe end points (EP). Using existing NTB it is possible to connect multiple CPUs and multiple switches having at least one NTB port, together creating small PCIe based clustered systems. There are many problems with existing PCIe NTB based network. One of the major problems with the existing NTB architecture is that any time the packets are forwarded between NTB ports, a memory address translation needs to be performed resulting in high processing overhead when the system has many different devices connected together resulting in many translation and higher latency. Another problem is that these mechanisms use memory-mapped algorithms to provide very limited packet routing functionality, another problem relays in the lacks of many important features like e.g. large traffic congestion management and end-to-end flow control. All these features are needed by an interconnection network in order to be able to scale at very large number of nodes with no problems. Another problem is that with traditional NTB is possible to support only topologies with very limited number of nodes due to the lacks of real quality of services, traffic management and other network features.

We introduce a different kind of non-transparent bridging that we call distributed non-transparent bridging (dNTB). The dNTB is designed specifically to support the creation of large networks extending the PCIe features and capabilities and eliminating the limitations that normally belong to the today PCIe based network.

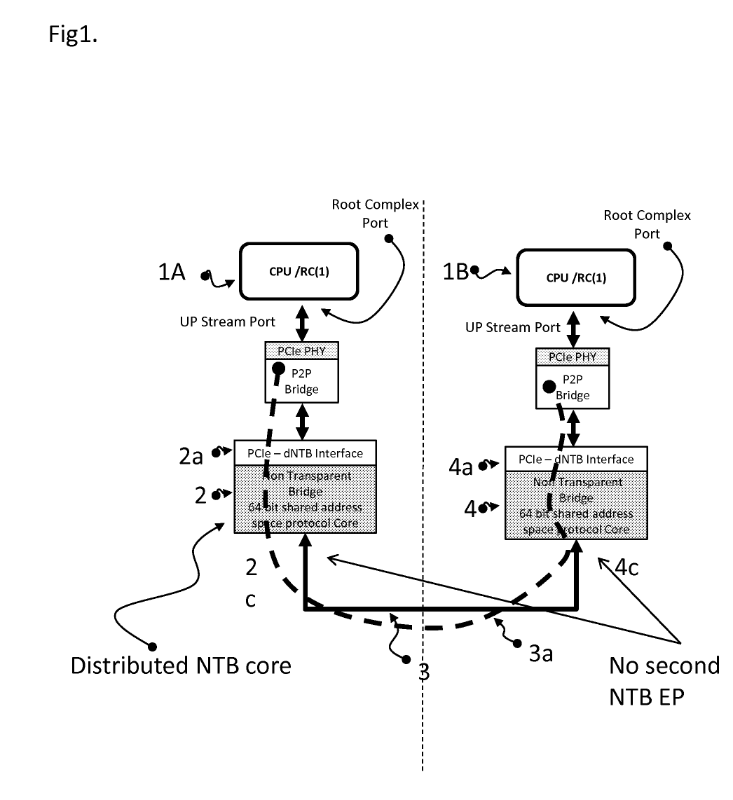

The NTB is a bridge realized to perform memory isolation between two different PCIe memory domains. Distributed non transparent bridging (dNTB) extends this simple bridge to a complete network architecture that not only perform the isolation of the memory domain between different PCIe memory domains, but introduces also all the functionality needed to create a fabric. The FIG. 1 describes the implementation of distributed NTB where the classic architecture of the NTB is redesigned using a different approach. The NTB end point, a PCIe-dNTB interface (2a), is attached to a non-transparent bridging core (2) realized using a global shared memory capable protocol. This core performs the memory translations between the PCIe protocol and a second memory mapped protocol used as a bridge. The result of this operation is a complete isolation between the PCIe memory domain and the secondary bus memory domain exactly how happens in the traditional NTB. The main feature required by this bridge protocol is that it must be capable of at least 64 bit of memory mapping and must support a globally shared memory address.

The resulting memory translation between the PCIe and the distributed non-transparent bridging (dNTB), is conceptually identical to the memory translation performed by the existing PCIe NTB but, on the contrary of the exiting NTB, the memory mapping performed using a secondary memory mapped bus permits to extend the functionality of the NTB outside of a single component creating a distributed non-transparent bridging (dNTB) network that can, directly, connect multiple PCIe devices enabling the creation of a virtual single system image switch that aggregates multiple switches into a virtual single one. The main effect of using a globally shared memory capable bus is that of realizing a globally shared memory space between the NTB cores (FIG. 1; 2, 4). In other words, the two NTB functions can belong to two different chips.

The globally shared memory space between each NTB core permits to have a globally shared translation table and routing table that take care of the correct translation and routing of the packets involved in the communication between the devices.

The protocol used for the bridging can be any protocols with shared memory support, it can be for example Hypertransport or HyperShare™ from Hypertransport Consortium, RapidIO™, Scalable Coherent Interface (SCI), Quick Path Interconnect (QPI) or any other memory mapped bus comprising special property busses as proprietary exotic bus with at least 64 bit of memory addressing capabilities. Architecturally speaking is possible to realize a new NTB where as described in the FIG. 1, the NTB core (2), is not connected directly with a second NTB EP inside the same chip, as in today's NTB architecture, but it is connected to a second NTB core (4) using a fabric connected to the network interface 2c and 4c. The network interface is connected using the link (3) with an equivalent second NTB network interface (4c). The architectural result is a NTB interface where the 1^{st} EP is represented by the interface (2a) and the second NTB EP is represented by the interface (4a). The combination of the two parts creates exactly the same architecture linkages of the classical NTB but with major improvements in capability: this new NTB architecture is distributed and the 1^{st} NTB EP and the 2^{nd} NTB EP can belong to two different switches, contrary to today's NTB architecture that requires that the two NTB EPs belong to the same switch. The bridging protocol used by the new NTB core is realized to provide all the network functionalities needed for the creation of a robust interconnection fabric. In this new approach, we have also several immediate benefits compared with the traditional NTB architecture: 1^{st} we eliminate the complexity of the multiple translation needed when you connect two different devices using traditional NTB ports. In traditional NTB in fact each single device need to open and close the translation inside the device resulting in multiple translation when you need to connect multiple NTB ports that belong to different devices. 2^{nd} we maintain the NTB main concepts while eliminating the latency derived from the use of multiple memory translation between different NTB interfaces when you connect different systems, especially when you involve complex topologies. 3^{rd} we introduce a distributed NTB (dNTB) concept that can be managed as an interconnection network fabric with all the quality of services, the flow controls, the traffic congestion management and the routing policy needed to create a scalable network fabric between multiple NTB EPs. 4^{th} the resulting interconnection fabric can easily scale by taking full advantage from the protocol chosen for the bridging implementation. For example using RapidIO as protocol to realize the dNTB core the network can scale up to 2¹⁶ dNTB nodes or end points, or more. The resulting dNTB fabric provides robust error detection with hardware based recovery mechanisms, end to end flow control with a Cyclic Redundancy Check (CRC), it has a hardware-based recovery mechanism, and, in addition, it can support hot-swap and other features.

This new NTB architecture can be considered a distributed NTB architecture based on a globally shared memory address space implementation and enables the creation of complex packets routing paths providing all the capabilities to build PCIe based clusters with large dimensions. The dNTB mechanisms are transparent to the PCIe resulting functionality exactly as in the common PCIe NTB. The data flow is represented by the line (3a). The NTB core 2 and 4 can be considered as a virtual single one. At a high level, the driver uses shared memory as means of communication between the systems connected via dNTB interconnect. The driver establishes IPC protocol that allows systems to discover each other and share the memory information. IPC is done over message registers and data is typically transferred using DMA. Events can be sent using Doorbell registers. The events could be used by IPC or data transfer.

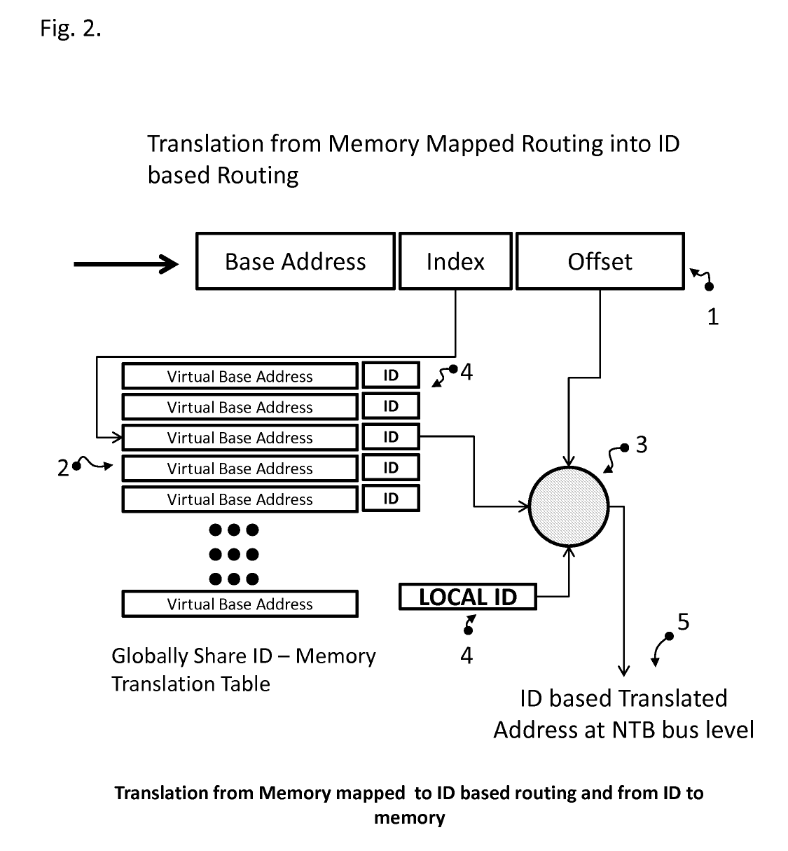

FIG. 2 shows a possible simplified implementation of the translation mechanism used in the distributed NTB (dNTB). This mechanism is derived directly by the similar mechanism used in the NTB. We have two major differences from the classic NTB translation mechanism, the 1^{st} one is the introduction of the unique ID base routing for all the operation involved in the communication mechanism, instead of the hybrid memory mapped and ID routing used by the common NTB. This means that each memory address is combined with an ID and this ID is used for routing at any level inside the NTB fabric. The incoming memory address request (1) is translated into the table (2) and each memory address will be associated with an ID (4) that represents the ID of the local node to which the memory adders is related. One finite state machine (3) adds the local ID as sender identification. The memory translation request is ready for the NTB fabric (5). Note that each switch must have a unique local ID for routing. The 2^{nd} major difference from the classic NTB translation mechanism is that this new translation model permits the use of only two translations in any possible NTB configuration even when the systems require multiple NTBs.

The table 2 is globally shared among all the dNTB end points present in the dNTB network.

The table can contain both the address of dNTB end point and PCIe endpoints (Ms), in this way is possible to realize the remote I/O addressing and the direct communications between different dNTB end points.

The system driver provides, at boot time, the table configuration for each end point present in the cluster. This architecture permits, in easy way, to implement different routing algorithms in order to support different topologies.

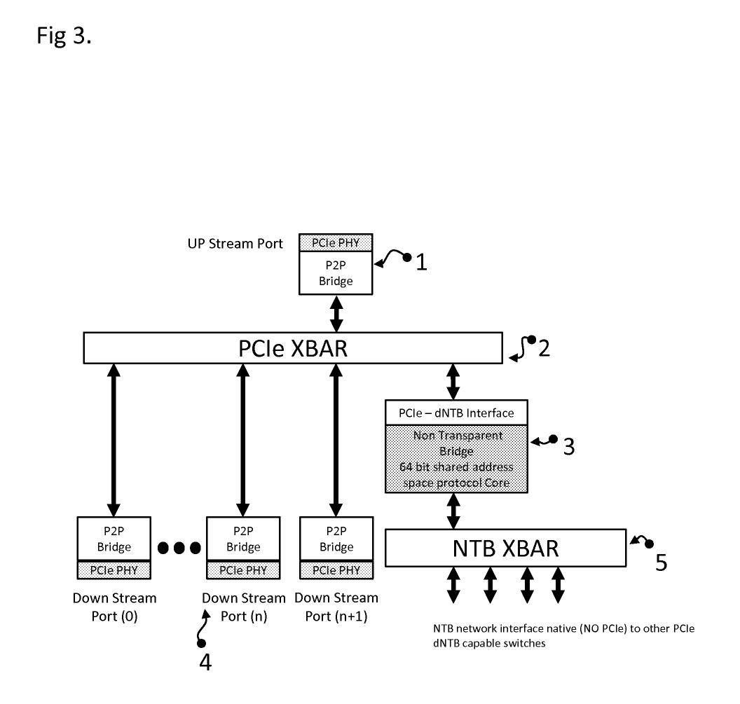

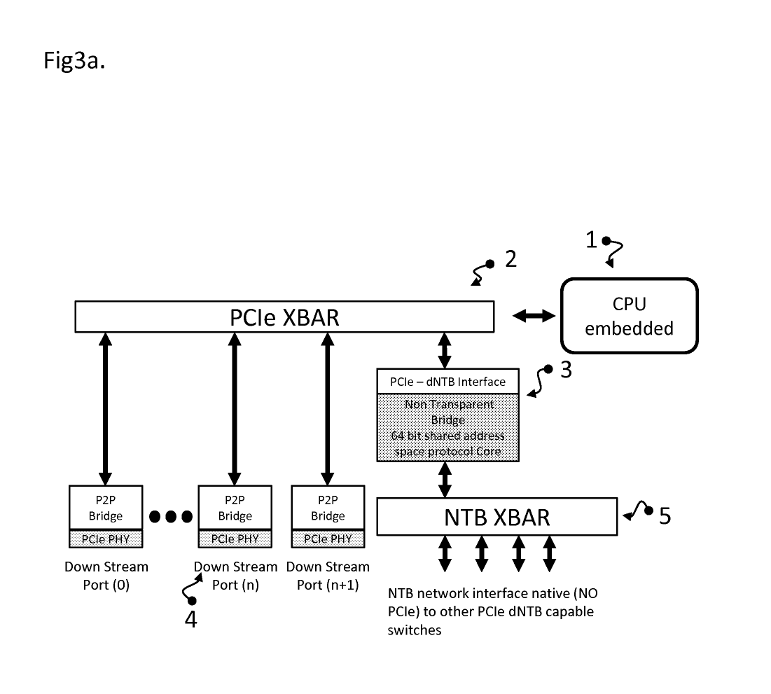

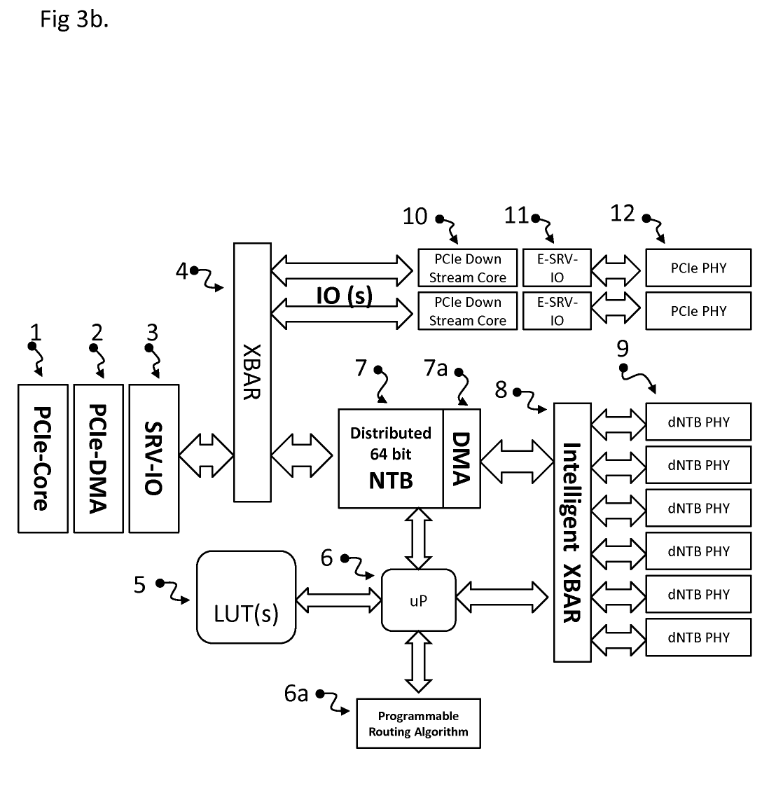

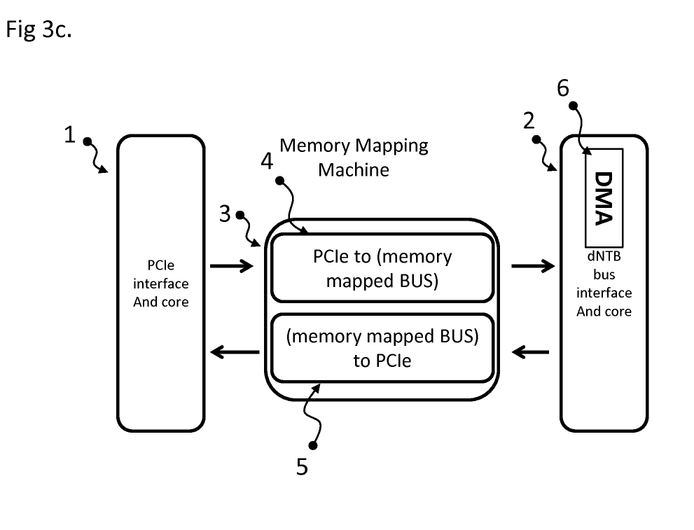

FIG. 3 shows a possible single device configuration where the root complex upstream port (1) is connected to a PCIe switch (e.g. crossbar) (2). The PCIe cross bar has multiple ports. Some of these ports (4) are configured as standard PCIe downstream ports and can be used to connect PCIe compliant external EPs. The crossbar (2) connects also at least one distributed NTB core (3). The core (3) is connected to crossbar (5) that has at least one port used to connect the second distribute NTB core (local or remote). The cross bar (5) is used for the dNTB interconnection fabric. The XBAR 5 performs the routing of the packets among different ports and in case of using RapidIO as dNTB bus it can be considered like a standard switch realized using the RapidIO specifications.

FIG. 3a shows in one preferred embodiment for the switch core a configuration where an embedded CPU (1) is used for the PCIe enumeration of the local EPs (4) avoiding the necessity for an external CPU. The embedded CPU is attached to the crossbar (2) using a PCIe root complex interface. This configuration can be used to add PCIe EPs to a distributed NTB fabric without adding CPUs.

This implementation can be used to realize cluster of shared I/Os like PCIe based network cards, e.g. Ethernet cards, PCIe based accelerators and more in general, any PCIe based devices.

FIG. 3b shows in one preferred embodiment a complete distributed non transparent bridge (dNTB) switch core. In this embodiments we have multiple PCIe ports organized as upstream port (only one) and multiple downstream ports. The upstream port is used to connect root complex and CPUs to the PCIe switches. The downstream ports are used to connect PCIe capable end points. The switch has inside the engine that provides all the features needed for the dNTB operations. More in detail we have the PCIe core and Physical Interface (PHY) (1) that is used to connect the root complex and the CPUs to the switch core. The Core (1) has the DMA interface (2) and a Single Root Virtualization IO (SRV-IO) (3) interface supporting multiple functions. The SRV-IO (3) is used for applications involving virtual machines. The cores (1),(2),(3) are connected to a PCIe crossbar (4) that is used to connect different cores providing the necessary packets switching. The crossbar can have multiple PCIe downstream cores (10) with their own SRV-IO cores (11) supporting multiple functions. The PCIe PHYs (12) provide the interface with PCIe capable standard EPs. The number of PCIe downstream cores is limited only by the cost of the chip. The crossbar (4) provides the access to the dNTB core (7). The dNTB core (7) is realized using a PCIe mapping on at least but not limited to a 64 bit memory mapped bus, that is also capable of providing at protocol level all the functionalities needed by a robust interconnection fabric. The dNTB core (7) has its own DMA engine (7a) that is used for large transfer operations. The dNTB core (7) is connected to an intelligent crossbar (8). The intelligent cross bar is driven by the microprocessor (6) that is used to manage all the functions of the dNTB core (7). The microprocessor (6) reads from the Memory Lookup Tables (LUTs) (5) the memory address that must be translated, adds the right identification ID (local) and reads the algorithm from the programmable routing table (6a) and provides the information for the routing to the intelligent crossbar (8). The microprocessor (6) can also take care about all the quality of services needed by the fabric. The intelligent crossbar (8) has multiple ports for the dNTB interconnection fabric operation and connectivity each with its own PHY (9). The microprocessor can be substituted by any devices or logical function that can perform the same operations.

FIG. 3c shows how the dNTB core can be organized. The main function of the core is to translate the memory address from PCIe to a dNTB address in the globally address space and vice versa. The core should also provide the interrupts and the registers that can be used in applications in order to realize an efficient communication. As example the core can perform the operation in the way here described: A PCIe interface (1) is used to interface the PCIe bus with the mapping engine (3), the mapping engine (3) is connected to the dNTB bus interface (2) that is used to interface the dNTB with the other dNTB fabric components (e.g. dNTB PHYs). The mapping engine (3) has two major components: the PCIe to dNTB bus mapping core (4) that performs the memory mapping and packets communication translating the PCIe into the dNTB bus, and the dNTB to PCIe bus mapping core (5) that performs the memory mapping from the global shared memory address space of the dNTB into PCIe interface enabling the communication between the dNTB fabric and the PCIe interface. The dNTB interface (2) can be provided with an internal DMA engine (6) used for large data transfer between the dNTB fabric and the PCIe interfaces. The PCIe interface has multiple base address registers (BARs) (e.g. six BARs from BAR(0) to BAR(5)). BAR(0) is usually organized in 32 bit non-prefetchable memory used for configuration and internal memory mapping. BAR(1) is usually a 32 bit non-prefetchable memory used for doorbells with memory window size of at least but not limited to 16 MB (mega bytes) to support multiple doorbell channels, BAR2 is combined with BAR3 in order to have 64 bit of memory addressing, a prefetchable memory configuration and aperture window of at least 16 MB (mega byte). BAR2 and BAR3 are used for mapping the PCIe interface (1) on the dNTB bus interface (2). BAR4 and BARS are combined together in order to provide 64 bit memory addressing, a prefetchable memory configuration with at least 16 MB (mega byte) of memory aperture window. BAR4 and BARS are used to map the dNTB interface (2) to the PCIe interface (1). In a preferred configuration the bridging BARs 4/5 and BARs 2/3 have multiple outbound addresses that can be associated to the BARs according with their base address configuration. Each window can support multiple sub zones of memory. This feature can be used for virtualization.

Different configurations can be used.

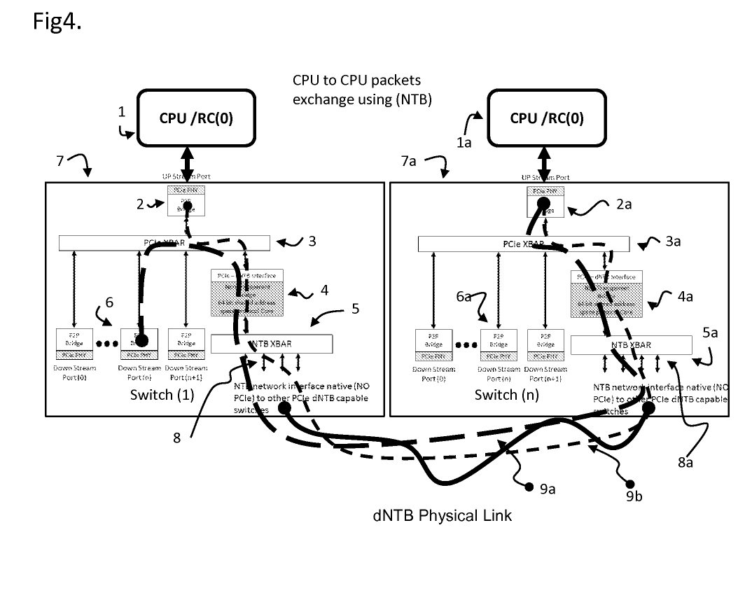

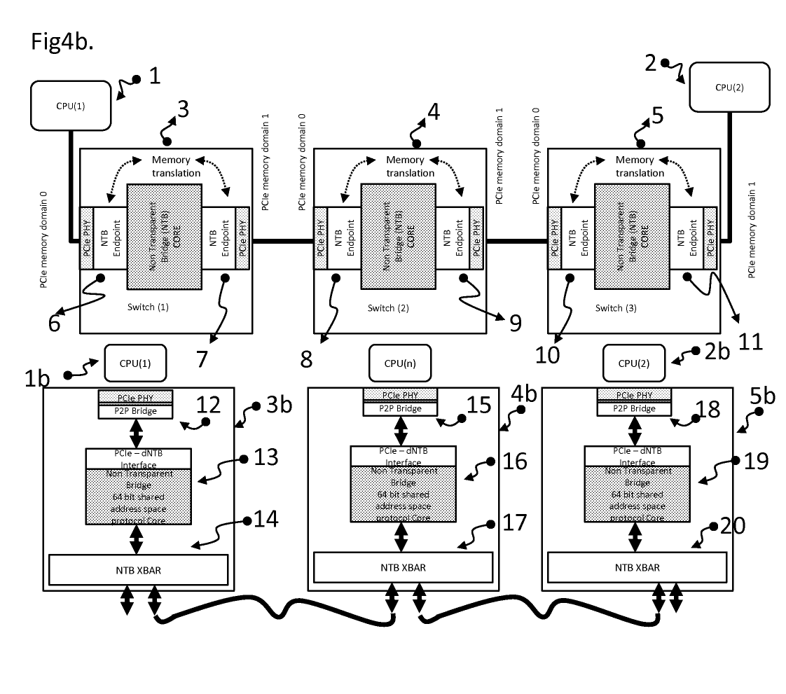

FIG. 4 shows in one preferred embodiment how the communication is performed between two different distributed NTB ports or fabrics. CPU (1a) can communicate with the CPU (1) sending packets through the PCIe upstream ports (2a) and the PCIe crossbar (3a) to the distributed NTB core (dNTB) (4a). The dNTB performs all the operations needed for the right address translation and all the operations for the needed routing. The dNTB core is connected with the crossbar (5a) that has at least one dNTB port (8a). The port (8a) is connected using an internal link, in case the two systems 7 and 7a are on the same silicon chip, or using an external PCB copper traces link or an external cable link (copper or optical) in case the systems 7 and 7a are two separate different chips (on the same PCB or not), to the second dNTB port (8) that is connected to the dNTB core 4 by the crossbar (5). The core (4) is connected to a PCIe crossbar (3) that connects multiple PCIe downstream ports (6) and to one PCIe upstream port (2). The port (2) is connected to the CPU (1). In the same way CPU (1a) can communicate with the PCIe EPs (6) using memory mapped virtualization performed by the global shared memory address space.

FIG. 4b shows the differences between the PCIe NTB as implemented in previous designs and the dNTB demonstrating the major efficiency of the dNTB compared with the existing NTB. The CPU (1) needs to communicate with the CPU(2). The CPU (1) is connected to the switch (3) and using the NTB port (6) and the NTB port (7) is connected to a second switch (4) that using the NTB port (8) and the NTB port (9) is connected to the switch (5) where through the NTB port (10) and the NTB port (11) is connected to the CPU (2). The system to work, as described before, needs to perform a memory address translation between the ports (6) and (7) and again another different address translation between the ports (8) and (9) and the latest different translation between the ports (10) and (11). In the dNTB configuration the CPU (1b) needs to communicate with the CPU (2b). The CPU (1b) is connected to a dNTB switch (3b) using the PCIe upstream port (12) and using the dNTB core (13) is connected to the dNTB crossbars (14) that is connected to the dNTB crossbar (17) on the switch (4b) that is connected to the dNTB crossbar (20) on the switch (5b) and finally through the dNTB core (19) and the PCIe upstream port (18) is connected with the CPU (2b). The result is that we don't need a memory translation for every switch. In this scenario the switch (3b) opens the memory address translation in the dNTB core (13) and performs an ID based routing of the packets. The crossbars (14), (17), (20) are used for the packet routing and they do not perform any kind of memory based operation. Finally the dNTB core (19) on the switch (5b) closes the memory translation. The result is that only one memory translation is needed in the dNTB architecture independently from the numbers of switches that are between the sender and the destination, dramatically reducing the number of operations involved in the inter switch communications. Any kind of memory translation does not involve the switch (4b) and uses only the dNTB crossbar (17) for routing.

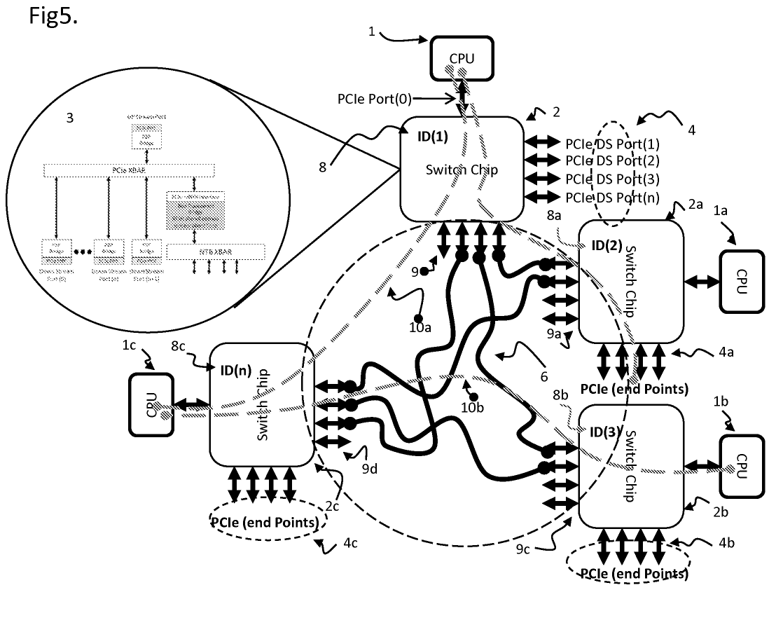

FIG. 5 shows, in some embodiments, how multiple switches can be connected together using dNTB fabric in order to create a large scalable virtual PCIe switch combining all the features described. Some CPUs ((1), (1a), (1b), (1c)) are connected each to a single dNTB capable switch. The switch architecture may be the one described in (3). Each single switch represents a separate memory domain in the PCIe hierarchy. Each switch has a single unique ID ((8), (8a), (8b), (8c)) that is used for the ID based routing as described before. Each single switch can have multiple PCIe downstream ports ((4), (4a), (4b), (4c)). These ports can be used for external EPs connection or for standard PCIe compliant transparent switches connections. Each chip has at least one dNTB fabric port ((9), (9a), (9b), (9c)). Multiple ports are needed to create complex fabric topologies. A dNTB fabric port in one chip (e.g. chip 2, port 9) can be connected directly to another equivalent port in a remote switch (e.g. chip 2c, port 9c) using a cable (6) that can be optical or copper. Using multiple dNTB fabric ports and cables you can connect multiple switches using complex topologies. The CPUs connected to the root complex port of each single chip can communicate with any other CPU and switch using the dNTB fabric.

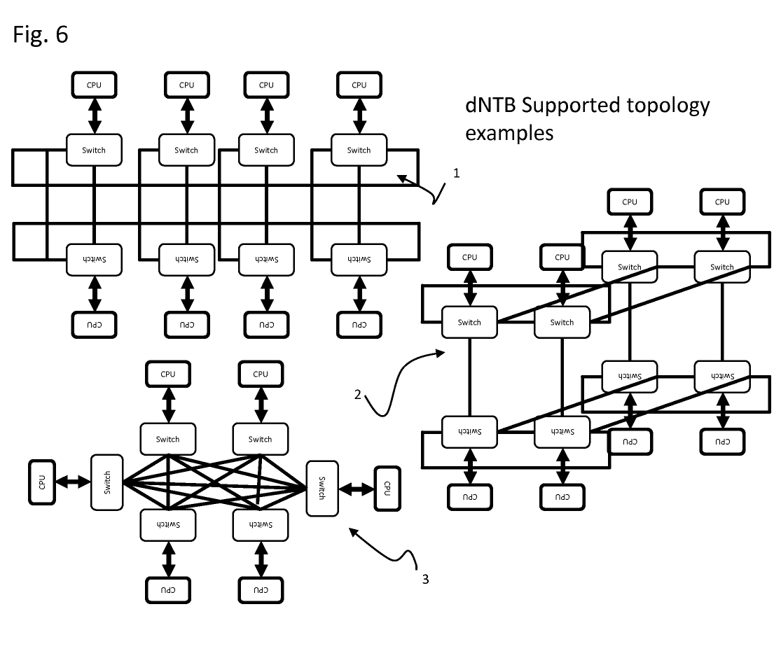

FIG. 6 shows some possible topologies supported by the dNTB fabric, but not limited to, 2D Torus (1), 3D Torus (2) and Star (3) topologies.

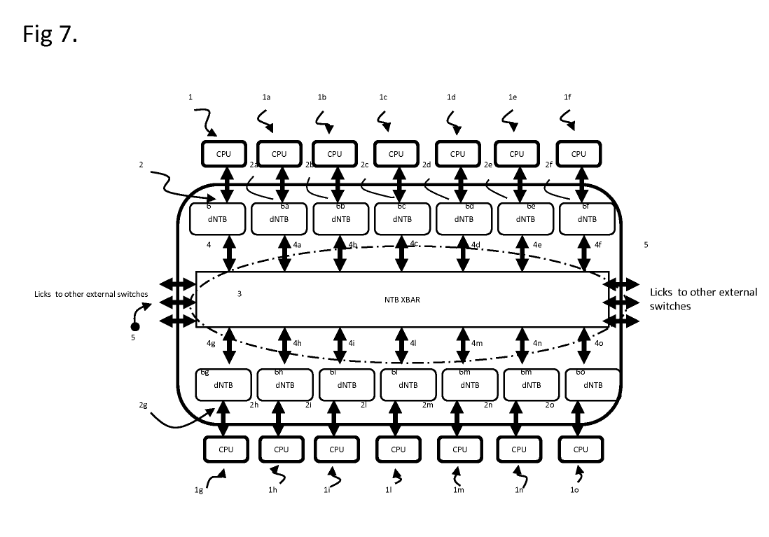

FIG. 7. Shows a possible single chip embodiment of the distributed NTB (dNTB) cores and related switch organization and implementation. In this configuration we have a single chip with many dNTB switches inside. Multiple CPUs ((1), (1a), (1b), (1c), (1d), (le), (1f), (1g), (1h), (1i), (1l), (1m), (1n), (1o)) are connected to a related dNTB capable switch core ((6), (6a), (6b), (6c), (6d), (6e), (6f), (6g), (6h), (6i), (6l), (6m), (6n), (6o)) through the PCIe upstream ports ((2), (2a), (2b), (2c), (2d), (2e), (2f), (2g), (2h), (2i), (2l), (2m), (2n), (2o)). Each switch core has at least one dNTB fabric port ((4), (4a), (4b), (4c), (4d), (4e), (4f), (4g), (4h), (4i), (4l), (4m), (4n), (4o)) that is used to connect the switch to a crossbar or to an embedded dNTB fabric (3). The crossbar or the embedded dNTB fabric has some dNTB fabric ports (5) used to connect other PCIe dNTB capable switches. Each switch single core ((6), (6a), (6b), (6c), (6d), (6e), (6f), (6g), (6h), (6i), (6l), (6m), (6n), (6o)) represents a single memory domain. This means that the CPU (1) with the switch (6) and the CPU (1a) with the switch (6a) belong to two different memory domains and cannot communicate directly to each other. This concept is valid for all the CPUs and the switches mentioned before. All the communications between two different memory domains are performed using the dNTB fabric with the mechanism described above.

### REFERENCES

### US Patent Documents

U.S. Pat. No. 8,429,325 B1 4/2013 Onufryk et al.

### Other Publications

PLX Technology Inc, Multi-Host System and Intelligent I/O Design with PCI Express
IDT Inc, PCIe Gen2 Switch Family Non-Transparent Operation Application Note AN-707

1. A highly scalable distributed, multi root, non-transparent memory bridging architecture and related implementation for Peripheral Component Interconnect express (PCIe) switches, created to connect multiple root complex and I/Os in a network, based on mapping the PCIe interfaces memory windows on a secondary bus that supports a globally shared memory architecture with ID based routing that isolates the different PCIe memory domains related to each single PCIe root complex, realized using a complementary bus with at least 64 bit of memory address space support, that is used as memory bridge between two or more different root complex memory domains, realizing a memory container where the PCIe memory address is translated into a secondary memory address associated with a relative identification (ID) and the packets can be routed in a network style architecture using ID routing based algorithms from one port to another and from one device to another in order to realize a highly scalable PCIE and I/O fabrics, comprising: at least a secondary memory mapped bus with at least 64 bit of memory addressing support used to bridge the memory address from one root complex memory domain to another one; at least a PCIe upstream port; at least one interconnection port based on the distribute non transparent bridging bus that can be used to connect other equivalent devices.

2. A distributed non-transparent memory bridging architecture and related implementation where the bus used for the non-transparent bridging implementation and the hardware core that implements provides also all the capabilities needed for a robust inter-processor network fabric, including link to link flow control, end to end flow control, traffic congestion management, complex routing capabilities and support for any topology like, but not limited at, 1D, 2D, 3D, xD Torus and derived topologies, 1D, 2D, 3D, nD Hypercube topologies, tree topologies, star topologies, with built in fault tolerant architecture.

3. A distributed non-transparent memory bridging architecture and implementation where a secondary bus is used for the realization of the PCIe non transparent bridging that can be used outside a single chip in order to realize a distributed non transparent bridging scalable fabric designed to extend the capability of the PCIe realizing a distributed single system image PCIe switch architecture that can comprise at least one or multiple up stream ports and eventually one or multiple PCIe downstream ports.

4. The distributed non-transparent memory bridging architecture and implementation of claim 1 where the invention can be realized in Upstream/Root Complex-NTB simple building block with no PCIe downstream transparent ports for I/O connectivity and at least one dNTB port used to connect a second PCIe dNTB capable device.

5. The distributed non-transparent memory bridging architecture and implementation of claim 1 where the invention can be realized in Upstream/Root Complex-NTB fabric configuration with many PCIe transparent bridging ports, downstream ports, connected to the root complex providing an efficient way to connect multiple root complex and different PCIe end points in the same fabric enabling the creation of hybrid multi root PCIe fabric with PCIe end point virtual sharing capabilities and node to node internetworking capability with high scalability in a single fabric.

6. The distributed non-transparent memory bridging architecture and implementation of claim 1 where the invention can be realized to create multi NTB ports in combination with transparent bridging capabilities and PCIe transparent ports connected in a way that each root complex can have one or more transparent ports (downstream ports in the PCIe switch convention) connected directly to it using the standard PCIe transparent bridging and switching architecture and one distributed non transparent bridging port connected to one of the downstream ports realizing an hybrid group of ports.

7. The distributed non-transparent memory bridging architecture and implementation of claim 1 where the invention is realized in a single chip comprising multiple PCIe downstream ports and that is equipped with an embedded microprocessor that performs directly the enumeration of the end points connected to the PCIe transparent downstream ports eliminating the needing to have a root complex CPU connected to the switch permitting the creation of clustered shared I/Os without the needing of a root complex.

8. The distributed non-transparent memory bridging architecture and implementation of claim 1 where the invention relates to a PCIe switch assembly based on a scalable distributed non transparent bridging complementary bus that realizes highly scalable, low latency fabric with the capability to support direct memory based I/O virtualization and supporting any network topology.
